(19) United States
(12) Patent Application Publication
(10) Pub. No.: US 2023/0052967 A1
(43) Pub. Date: Feb. 16, 2023

(54) Snow Shovel Deicer Device

(71) Applicants: Kevin Christopher Nicholson, Mount Juliet, TN (US); John Bryce Martin, Mount Joliet, TN (US)

(72) Inventors: Kevin Christopher Nicholson, Mount Juliet, TN (US); John Bryce Martin, Mount Joliet, TN (US)

(21) Appl. No.: 17/494,912

(22) Filed: Oct. 6, 2021

Related U.S. Application Data
(60) Provisional application No. 63/232,689, filed on Aug. 13, 2021.

(51) Int. Cl. E01H 5/12; A01B 1/02; E01H 10/00

(52) U.S. Cl. CPC E01H 5/12; A01B 1/02; E01H 10/007

(57) ABSTRACT

The present invention relates generally to the field of snow shovels. More specifically, the present invention relates to a snow shovel deicer device primarily comprised of a handle, a shaft, a dispensing unit, a secondary housing, a shovel head and a de-icing bottle filled with de-icing solution. A button on the handle of the device can be depressed to dispense de-icing solution from nozzles that may be located on the shaft and the rear of the shovel head. In this manner, a user can shovel snow with the shovel head while simultaneously de-icing the area he or she has just shoveled. In differing embodiments, the shovel head may be removable, such that a user can use the shaft and nozzle located on the shaft to de-ice or pretreat an area prior to inclement weather.

### CROSS-REFERENCE TO RELATED APPLICATION

The present application claims priority to, and the benefit of, U.S. Provisional Application No. 63/232,689, which was filed on Aug. 13, 2021, and is incorporated herein by reference in its entirety.

### FIELD OF THE INVENTION

The present invention relates generally to the field of snow shovels. More specifically, the present invention relates to a snow shovel device primarily comprised of a handle, a shaft, a dispensing unit, a secondary housing, a shovel head and a de-icing bottle filled with de-icing solution. A button on the handle of the device can be depressed to dispense de-icing solution from nozzles that may be located on the shaft and the rear of the shovel head. In this manner, a user can shovel snow with the shovel head while simultaneously de-icing the area they have just shoveled. In differing embodiments, the shovel head may be removable, such that a user can use the shaft and nozzle located on the shaft to de-ice or pretreat an area. Accordingly, the present disclosure makes specific reference thereto. Nonetheless, it is to be appreciated that aspects of the present invention are also equally applicable to other like applications, devices and methods of manufacture.

### BACKGROUND

In winter climates, snow must be regularly removed from driveways, sidewalks and other areas of a home or business to allow individuals to safely access their home or business. Removing snow is often achieved using a snow shovel or snow blower and can be extremely physically exhausting and stressful. However, once snow has been removed from a surface, ice may still be present on the surface. This ice must then be removed. If not removed, said ice could cause an individual to slip and fall, which could lead to severe injury or even death.

Removing ice requires an individual to place salt down onto the iced surface. However, this requires an entirely separate process from shoveling snow. Therefore, this additional process can further exhaust a user. In addition, salt may also damage the surface it is applied to, which can lead to extensive repairs.

Therefore, there exists a long-felt need in the art for an improved device that allows a user to clear snow and remove ice from a surface simultaneously. There also exists a long-felt need in the art for a snow shovel device that can be used to de-ice a surface, wherein the device does not require a user to spread salt onto the surface to achieve ice removal. Finally, there exists a long-felt need in the art for a snow shovel device that does not require additional physical effort on the part of the user to de-ice a surface from which he or she is already shoveling snow from.

The subject matter disclosed and claimed herein, in one embodiment thereof, comprises a snow shovel device. The device is primarily comprised of a handle, a shaft, a dispensing unit, a secondary housing, a shovel head and a de-icing bottle filled with de-icing solution. A button on the handle of the device can be depressed to dispense de-icing solution from nozzles that may be located on the shaft and the rear of the shovel head. In this manner, a user can shovel snow with the shovel head while simultaneously de-icing the area he or she has just shoveled. In differing embodiments, the shovel head may be removable, such that a user can use the shaft and nozzle located on the shaft to de-ice an area.

In this manner, the snow shovel deicer device of the present invention accomplishes all of the forgoing objectives and provides an improved snow shovel device. The device allows a user to clear snow and remove ice from a surface simultaneously, without requiring a user to spread salt onto a surface manually. In addition, the device does not require additional physical effort on the part of the user to de-ice a surface from which he or she is already shoveling snow from.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a snow shovel device. The device is primarily comprised of a handle, a shaft, a dispensing unit, a secondary housing, a shovel head and a de-icing bottle filled with de-icing solution. The handle is fixedly-secured to the first end of the shaft, and is further comprised of a continuous opening to allow users to place their hands on/through the handle. The handle is also comprised of a textured grip and a button that can be depressed to dispense the de-icing solution from the device. A shovel head is located on the second end of the shaft and may be fixedly-secured to the shaft or may be removably-secured by female threads that engage a plurality of male threads on the second end of the shaft or via a fast attaching/detaching mechanism.

The second end of the shaft is also comprised of a dispensing unit, a secondary housing and a selection knob. The dispensing unit of the shaft receives a de-icing bottle that contains a de-icing solution that breaks down and melts ice on a surface. Tubing or conduits further connect to the dispensing unit to allow the solution to travel to the nozzle and/or shovel head. In order to facilitate the transfer of the solution to the nozzle and/or shovel head, the dispensing unit has an internal motor and internal pump, wherein the motor powers the pump and is powered by a battery.

After the button on the handle is pressed by a user, the pump begins to pump de-icing solution from the bottle through the tubing within the shaft. The solution then travels through the tubing to a secondary housing, where it is expelled via a nozzle. The nozzle may be configured at a plurality of adjustable angles, such that it can be positioned to spray solution in a manner that does not allow the solution to get on the legs/boots of a user. Therefore, a user can use the shovel head to shovel snow and simultaneously spray de-icing solution to break down ice in the same area, without the need for additional equipment.

The tubing may also connect to the shovel head to allow solution to be expelled via the at least one nozzle located on the rear surface of the shovel head. The at least one nozzle may be configured at a plurality of adjustable angles, such that it can be positioned to spray solution in a manner that does not allow the solution to get on the legs/boots of a user. In this manner, a user can use the shovel head to shovel snow and simultaneously spray solution to break down ice in the same motion. The selection knob of the device also allows a user to select whether the de-icing solution exits both of the nozzles, either nozzle or no nozzle, wherein the knob may be located on the secondary housing or the shovel head. In addition, the shovel head can be removed from the shaft to allow a user to use only the shaft to dispense de-icing solution through the secondary housing.

Accordingly, the improved snow shovel device of the present invention is particularly advantageous as it allows a user to clear snow and remove ice simultaneously. The device can also be used to de-ice a surface, wherein the device does not require a user to spread salt onto the surface. Finally, the device does not require additional physical effort on the part of the user to de-ice a surface from which he or she is already shoveling snow from.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the snow shovel device of the present invention in accordance with the disclosed architecture;

FIG. 2 illustrates an enhanced perspective view of one potential embodiment of a handle of the snow shovel device of the present invention in accordance with the disclosed architecture;

FIG. 3 illustrates an enhanced perspective view of one potential embodiment of a shovel head of the snow shovel device of the present invention in accordance with the disclosed architecture;

FIG. 4 illustrates an enhanced perspective view of one potential embodiment of the dispensing unit of the snow shovel device of the present invention in accordance with the disclosed architecture;

FIG. 5 illustrates an enhanced perspective view of one potential embodiment of the snow shovel device of the present invention shoveling snow and spraying de-icing solution in accordance with the disclosed architecture; and

FIG. 6 illustrates a perspective view of one potential embodiment of the snow shovel device of the present invention including a plurality of nozzles for dispensing de-icing solution in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved device that allows a user to clear snow and remove ice simultaneously. There also exists a long-felt need in the art for a snow shovel device that can be used to de-ice a surface, wherein the device does not require a user to spread salt onto the surface. Finally, there exists a long-felt need in the art for a snow shovel device that does not require additional physical effort on the part of the user to de-ice a surface from which he or she is already shoveling snow from.

The present invention, in one exemplary embodiment, is comprised of a snow shovel device comprising a handle, a shaft, a dispensing unit, a secondary housing, a shovel head and a de-icing bottle filled with de-icing solution. The handle is fixedly-secured to the first end of the shaft and is further comprised of a continuous opening to allow users to place their hands on/through the handle. In addition, the handle has a textured grip and a button that can be depressed to dispense the de-icing solution from the device. A shovel head is also located on the second end of the shaft and may be fixedly-secured to the shaft or removably-attached by female threads that engage a plurality of male threads on the second end of the shaft or via a fast attaching/detaching mechanism.

The second end of the shaft is further comprised of a dispensing unit, a secondary housing and a selection knob. The dispensing unit receives a de-icing bottle that contains de-icing solution that breaks down and melts ice present on a surface. Tubing within the shaft further connects to the unit to allow solution to travel to the nozzle and/or shovel head. In order to facilitate the transfer of the solution to the nozzle and/or head, the unit has an internal motor and internal pump wherein the motor powers the pump and is powered by a battery.

The pump begins to pump de-icing solution from the bottle through the tubing within the shaft after the button on the handle is pressed by a user. The solution then travels through the tubing to a secondary housing, where it is expelled via a nozzle. It is contemplated that the nozzle may be configured at a plurality of adjustable angles, such that it can be positioned to spray solution in a manner that does not allow the solution to get on the legs/boots of a user. The tubing may also connect to the shovel head to allow solution to be expelled via the at least one nozzle located on the rear surface of the shovel head, wherein the at least one nozzle may be configured at a plurality of adjustable angles, such that it can be positioned to spray solution in a manner that does not allow the solution to get on the legs/boots of a user. As a result, a user can use the shovel head to shovel snow and simultaneously spray solution to break down ice in the same motion. The selection knob of the device also allows a user to select whether solution exits both of the nozzles, either nozzle or no nozzle. In differing embodiments, the knob may be located on the secondary housing or the shovel head. In addition, the shovel head can be removed from the shaft to allow a user to use only the shaft to dispense solution through the secondary housing.

Accordingly, the improved snow shovel deicer device of the present invention is particularly advantageous as it allows a user to clear snow and remove ice simultaneously, while not requiring a user to spread salt on the surface, and prevents the accumulation of ice on a surface. Finally, the device does not require additional physical effort on the part of the user to de-ice a surface that he or she is also simultaneously shoveling.

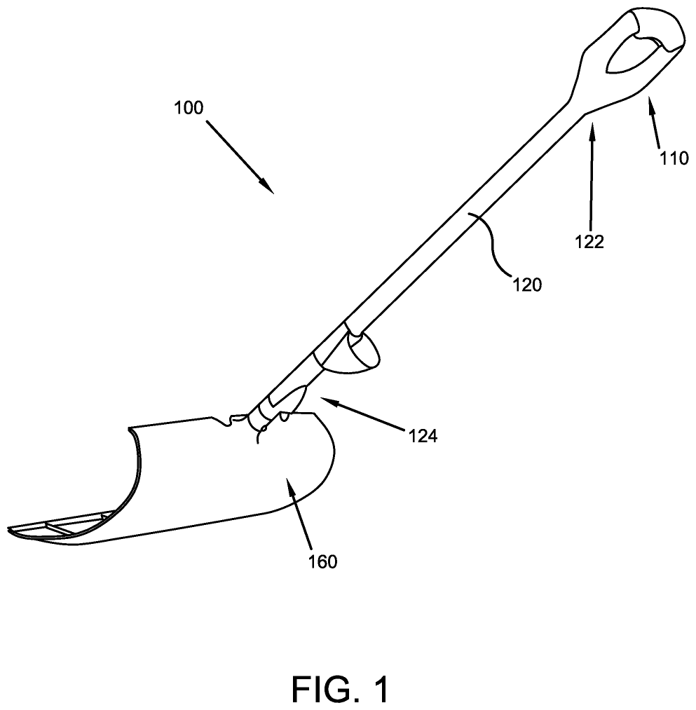

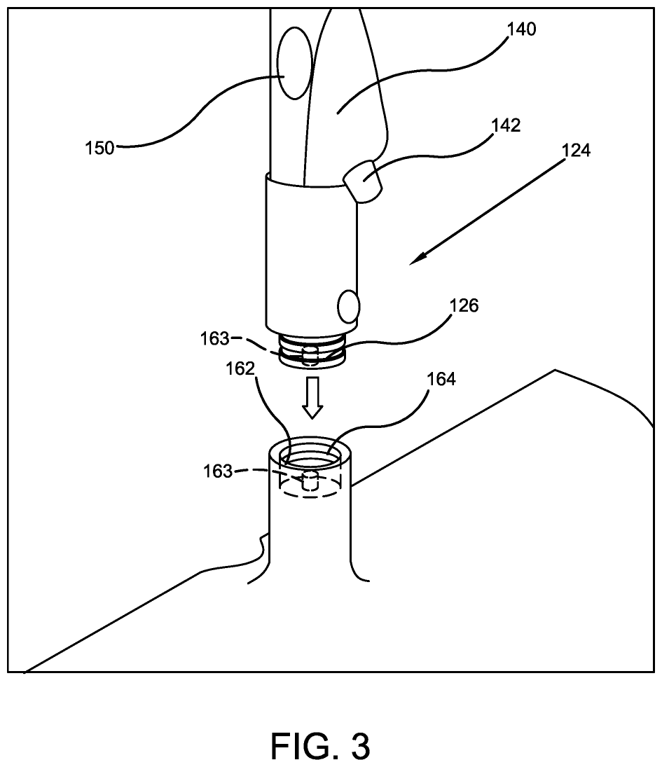

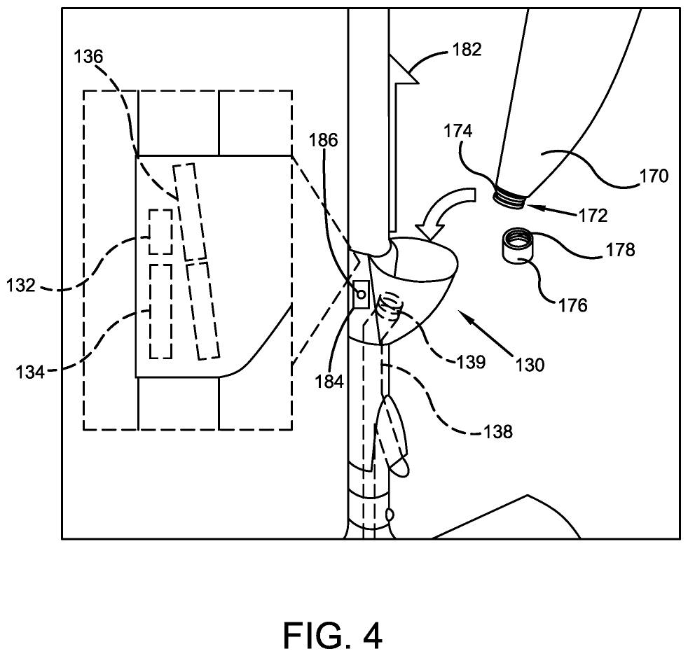

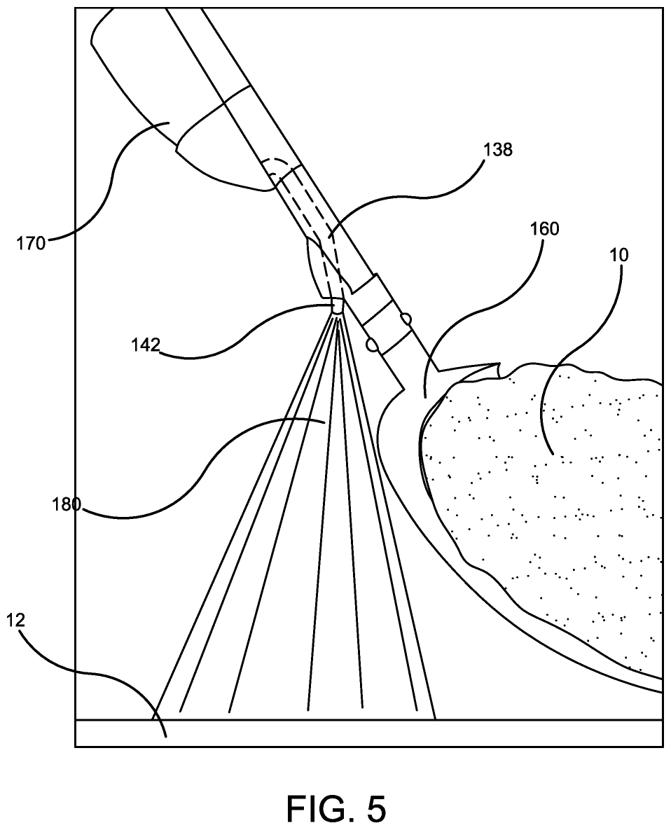

Referring initially to the drawings, FIG. 1 illustrates a perspective view of one embodiment of the snow shovel deicer device 100 of the present invention. The device 100 is primarily comprised of a handle 110, a shaft 120, a dispensing unit 130 (shown in FIG. 4), a secondary housing 140 (shown in FIG. 3), a shovel head 160 and a de-icing bottle 170 (shown in FIG. 4) filled with de-icing solution 180 (shown in FIG. 5). In differing embodiments, all components of the device 100 may be comprised of a durable metal such as, but not limited to, stainless steel, aluminum and/or a plastic, such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any combination thereof.

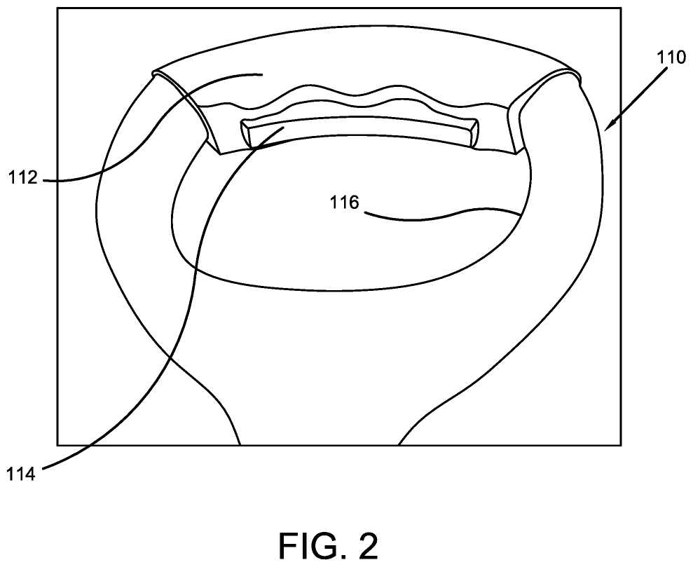

FIG. 2 illustrates an enhanced perspective view of a handle 110 of the snow shovel device 100 of the present invention. The handle 110 is fixedly-secured to the first end 122 of the shaft 120, and allows a user to control and maneuver the device 100. The handle 110 is fixedly-secured to the shaft 120 via being pinned, threaded, etc., or via any other suitable fastening means as is known in the art. Alternatively, the handle 110 and the shaft 120 could be a one-piece molded plastic assembly, or the shaft 120 could be metal and the handle 110 plastic, which allows the plastic handle 110 to be pinned to the metal shaft 120. The handle 110 also has a continuous opening 116 of varying shape and size depending on the wants and/or needs of a user, that allows a user to place his or her hands through/around the handle 110. The handle 110 also has a textured hand grip 112 that may be rubber, plastic or any other suitable material as is known in the art, and may be of any type of texture that enhances the grip of a user's hand on the handle 110. The handle 110 is also comprised of a button 114 that can be depressed by a user to dispense de-icing solution 180 from the device 100, as will be described more fully below.

FIG. 3 illustrates an enhanced perspective view of a shovel head 160 of the snow shovel device 100 of the present invention. In one embodiment, the shovel head 160 is located on the second end 124 of the shaft 120, and may be fixedly-secured to the shaft 120. However, in the preferred embodiment, the shovel head 160 is removable from the shaft 120. In order to attach to the shaft 120, the head 160 has a continuous opening 162, wherein the interior surface of the opening 162 has a plurality of female threads 164 and an alignment notch 163. The female threads 164 engage a plurality of male threads 126 on the second end 124 of the shaft 120 to allow the shaft 120 to be removably-secured to the shovel head 160. In addition, the male threads 126 are comprised of a corresponding alignment notch 163 that matches up with the notch 163 of the female threads 164 to aid a user in attaching the shaft 120 to the shovel head 160. In any embodiment of the device 100, it is preferred that the shaft 120 and shovel head 160 are completely hollow or semi-hollow, and that the same allows for additional ways of attachment or detachment. In lieu of threads 164, 126 it is contemplated that the shaft 120 may also attach to the shovel head 160 via any fast attaching/quick attaching method known in the art.

FIGS. 3-4 illustrate an enhanced perspective view of the dispenser unit of the snow shovel device 100 of the present invention. The second end 124 of the shaft 120 further comprises a dispensing unit 130, a secondary housing 140 and a selection knob 150. The dispensing unit 130 receives a de-icing bottle 170 that contains de-icing solution 180 that breaks down and melts ice when applied to an ice-covered surface and/or that can be used to pretreat a surface. The bottle 170 is comprised of a spout 172 that has a plurality of male threads 174, which engage a plurality of female threads 139 within the hollow dispensing unit 130. Alternatively, other attachment means can also be used. The bottle 170 may also be comprised of a cap 176 that has a plurality of female threads 178. At least one piece of tubing or conduit 138 further connects to the unit 130 to allow the unit 130 to be placed into fluid communication with and to allow solution 180 to travel to the nozzle 142 and/or shovel head 160, as will be explained more fully below. In differing embodiments, the bottle 170 may be disposable or refillable. Further, the bottle 170 may additionally or alternatively be retained within the unit 130 via a retaining member 182 that secures the bottle 170 in a click-in securing fashion. In an additional embodiment, the bottle 170 may also have a spout 172 with no threads.

In order to facilitate the transfer of the solution 180 to the nozzle 142 and/or head 160, the unit 130 has an internal motor 132 and internal pump 134, wherein the motor 132 powers the pump 134 and the motor 132 is powered by at least one battery 136. The at least one battery 136 may be a disposable battery or a rechargeable battery in the form of an alkaline, nickel-cadmium, nickel-metal hydride battery, etc., such as any 3V-12 volt DC battery or other conventional battery such as A, AA, AAA, etc., or any other suitable battery known in the art that can supply power to the device 100. Throughout this specification the term “battery” may be used interchangeably to refer to one or more wet or dry cells or batteries of cells, in which chemical energy is converted into electricity and used as a source of DC power. References to recharging or replacing batteries may refer to recharging or replacing individual cells, individual batteries of cells or a package of multiple battery cells as is appropriate for any given battery technology that may be used. The motor 132, pump 134, and battery 136 may further be accessed within the unit 130 via a removable access panel 184 that can be secured via at least one fastener 186 such as but not limited to a screw, nut, bolt, magnet, etc.

FIG. 5 illustrates an enhanced perspective view of one embodiment of the snow shovel device 100 of the present invention shoveling snow 10 and spraying de-icing solution 180. After the button 114 is engaged by the user's hand, the pump 134 begins to pump de-icing solution 180 from the bottle 170 through the at least one piece of tubing or conduit 138 within the shaft 120. The solution 180 then travels through the tubing 138 to a secondary housing 140, wherein the solution 180 is expelled via at least one nozzle 142. The nozzle 142 may be configured at a plurality of adjustable angles, such that it can be positioned to spray solution 180 in a manner that does not allow the solution 180 to get on the legs/boots of a user. In this manner, a user can use the shovel head 160 to shovel snow 10 and simultaneously spray solution 180 behind the shovel head (wherein the solution 180 preferably sprays at the width of the shovel head 160) to break down ice 12 in the same area without the need for any additional motion or action to be performed.

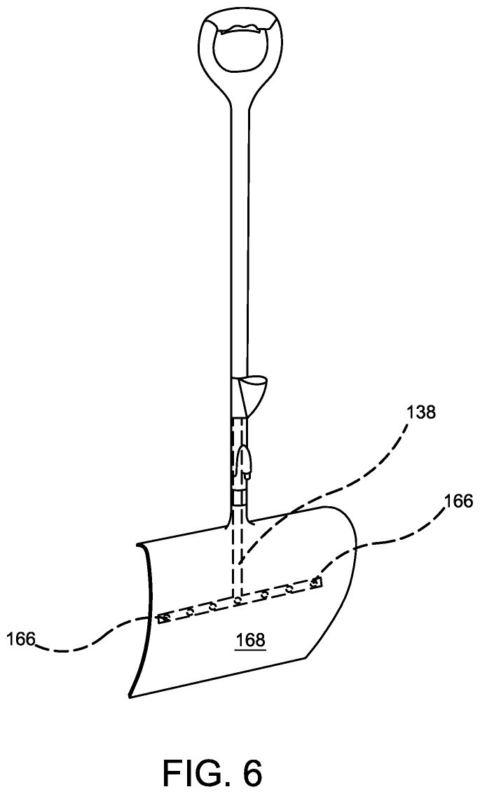

FIG. 6 illustrates a perspective view of one embodiment of the snow shovel device 100 of the present invention with a plurality of nozzles positioned on the shovel head 160. In an additional embodiment, the shovel head 160 may be comprised of at least one nozzle 166 on the rear surface 168 of the head 160. In addition to the at least one nozzle 142 of the secondary housing 140, the at least one nozzle 166 receives de-icing solution 180 from the bottle 170 after the button 114 is engaged by a user's hand. Specifically, once the button 114 is depressed, the pump 134 engages to pump de-icing solution 180 from the bottle 170 through the tubing 138 that extends from the shaft 120 and into the shovel head 160. The solution 180 is then expelled via the at least one nozzle 166. In one embodiment, the shovel head 160 comprises a plurality of nozzles 166 to dispense the de-icing solution 180. The at least one nozzle 166 may be configured at a plurality of adjustable angles, such that it can be positioned to spray solution 180 in a manner that does not allow the solution 180 to get on the legs/boots of a user but that is preferably not less than the width of the blade. In this manner, a user can use the shovel head 160 to shovel snow and simultaneously spray de-icing solution 180 to break down ice 12 in the same motion.

It should be appreciated that any embodiment of the device 100 may have at least one nozzle 142 located on the secondary housing 140, at least one nozzle 166 on the shovel head 160, or any combination thereof. In addition, the selection knob 150 of the device 100 also allows a user to select whether solution 180 exits both of the nozzles 142, 166, either nozzle 142, 166, or no nozzle 142, 166. In addition, the shovel head 160 can be removed from the shaft 120 to allow a user to use only the shaft 120 to dispense solution 180 from the nozzle 142 of the secondary housing 140, for the pretreatment of other areas. Although, the shovel head 160 can also be attached to allow for pretreatment of other areas.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “snow shovel device” and “device” are interchangeable and refer to the snow shovel device 100 of the present invention.

Notwithstanding the forgoing, the snow shovel device 100 of the present invention and its various components can be of any suitable size and configuration as is known in the art without affecting the overall concept of the invention, provided that they accomplish the above-stated objectives. One of ordinary skill in the art will appreciate that the size, configuration and material of the snow shovel device 100 as shown in FIGS. 1-6 is for illustrative purposes only, and that many other sizes and shapes of the snow shovel device 100 are well within the scope of the present disclosure. Although the dimensions of the snow shovel device 100 are important design parameters for user convenience, the snow shovel device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features, and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snow shovel deicer device that allows a user to clear snow and remove ice simultaneously from a surface and to pretreat the surface, the snow shovel deicer device comprising:
a shaft comprising a first end and a second end;
a handle secured to the first end of the shaft;
a shovel head secured to the second end of the shaft;
a dispensing unit;
a secondary housing and a nozzle, wherein the dispensing unit, the secondary housing, and the nozzle are secured to the second end of the shaft; and
a de-icing bottle that houses a de-icing solution, wherein the dispensing unit receives the de-icing bottle that contains the de-icing solution that breaks down and melts ice present on a surface.

2. The snow shovel deicer device of claim 1, wherein the handle comprises a continuous opening to allow a user to grip the handle.

3. The snow shovel deicer device of claim 1, wherein the shovel head is fixedly secured to the shaft.

4. The snow shovel deicer device of claim 1, wherein the shovel head is removably secured to the shaft via female threads that engage a plurality of male threads on the second end of the shaft.

5. The snow shovel deicer device of claim 1, wherein the dispensing unit sprays the de-icing solution from the nozzle located on the secondary housing.

6. A snow shovel deicer device comprising:
a shaft comprising a first end and a second end;
a handle comprised of a continuous opening and a button, wherein the handle is secured to the first end of the shaft;
a shovel head secured to the second end of the shaft, wherein the shovel head comprises at least one nozzle;
a dispensing unit located on the shaft comprising a motor, a pump, and a battery;
a secondary housing located on the shaft comprising at least one nozzle that expels a de-icing solution;
a de-icing bottle that houses the de-icing solution that breaks down ice, wherein the de-icing bottle is received by the dispensing unit;
a selection knob located on the shaft; and
at least one tubing component positioned within the shaft that allows the de-icing solution to be in fluid communication with the at least one nozzle of the secondary housing and the at least one nozzle of the shovel head.

7. The snow shovel deicer device of claim 6, wherein the de-icing solution can be sprayed from the at least one nozzle of the secondary housing and the at least one nozzle of the shovel head when the button of the handle is depressed.

8. The snow shovel deicer device of claim 7, wherein the motor powers the pump to allow the de-icing solution to move through the at least one tubing component to allow the de-icing solution to be sprayed from the at least one nozzle of the secondary housing and the at least one nozzle of the shovel head when the button of the handle is depressed.

9. The snow shovel deicer device of claim 8, wherein the motor is powered by the battery.

10. The snow shovel deicer device of claim 6, wherein the selection knob allows a user to select whether the de-icing solution exits both or one of the at least one nozzle of the secondary housing and the at least one nozzle of the shovel head.

11. A snow shovel deicer device comprising:
a shaft comprising a first end and a second end;
a handle comprised of a continuous opening, a textured grip, and a button, wherein the handle is secured to the first end of the shaft;
a shovel head secured to the second end of the shaft, wherein the shovel head comprises at least one nozzle;
a dispensing unit located on the shaft further comprised of an internal motor, an internal pump, and a battery;
a secondary housing located on the shaft comprising at least one nozzle that expels a de-icing solution;
a de-icing bottle that houses the de-icing solution that breaks down ice, wherein the de-icing bottle is received by the dispensing unit;
a selection knob located on the shaft; and
at least one tubing component positioned within the shaft that allows the de-icing solution to be in fluid communication with the at least one nozzle of the secondary housing and the at least one nozzle of the shovel head.

12. The snow shovel deicer device of claim 11, wherein the shovel head is fixedly secured to the shaft.

13. The snow shovel deicer device of claim 11, wherein the shovel head is removably secured to the shaft via female threads that engage a plurality of male threads on the second end of the shaft.

14. The snow shovel deicer device of claim 13, wherein the shovel head can be removed from the shaft to allow a user to use only the secondary housing and the at least one nozzle to dispense the de-icing solution.

15. The snow shovel deicer device of claim 11, wherein after the button is engaged by a user, the internal pump begins to pump the de-icing solution from the de-icing bottle through the at least one tubing component to the secondary housing and to the shovel head where the de-icing solution is expelled via the at least one nozzle of the secondary housing and the at least one nozzle of the shovel head.

16. The snow shovel deicer device of claim 15, wherein the at least one nozzle of the secondary housing and the at least one nozzle of the shovel head can be configured at a plurality of adjustable angles.

17. The snow shovel deicer device of claim 11, wherein a user can use the shovel head to shovel a plurality of snow and simultaneously spray the de-icing solution to break down an ice-covered surface in a same area without need for additional motion to be performed other than engagement of the button.

18. The snow shovel deicer device of claim 17, wherein the selection knob allows a user to select whether the de-icing solution exits both the at least one nozzle of the secondary housing and the at least one nozzle of the shovel head.

19. The snow shovel deicer device of claim 17, wherein the selection knob allows a user to select whether the de-icing solution exits the at least one nozzle of the secondary housing or the at least one nozzle of the shovel head.

20. The snow shovel deicer device of claim 17, wherein the selection knob allows a user to select whether the de-icing solution exits from neither the at least one nozzle of the secondary housing nor the at least one nozzle of the shovel head.
